(19) United States
(12) Patent Application Publication
(10) Pub. No.: US 2018/0019980 A1
(43) Pub. Date: Jan. 18, 2018

(54) SECURE FILE TRANSFER

(71) Applicant: CAMBRIDGE CONSULTANTS LIMITED, Cambridge, Cambridgeshire (GB)

(72) Inventor: Philip Edward DEMPSTER, Cambridge Cambridgeshire (GB)

(21) Appl. No.: 15/537,304

(22) PCT Filed: Dec. 17, 2015
(86) PCT No.: PCT/GB2015/054056

§ 371 Date: Jun. 16, 2017

(30) Foreign Application Priority Data
Dec. 18, 2014 (GB) 1422644.3

(51) Int. Cl. H04L 29/06; G06F 21/60; G06F 13/38; G06F 13/42; H04L 9/08; G06F 21/84

(52) U.S. Cl. CPC H04L 63/0428; H04L 9/0894; G06F 21/84; G06F 13/385; G06F 13/4282; G06F 21/602

(57) ABSTRACT

A system including a file transfer device connected to a first computer and a second computer, receives data from the first computer and stores the received data in an encrypted data store. The file transfer device provides the stored data to the second computer when requested, and renders the stored data unreadable to either computer upon disconnection from at least one of the first and second computers.

The present invention relates to a computer system. The invention has particular but not exclusive relevance to computer systems and devices thereof equipped with an external communication connector/interface, such as an interface operating in accordance with the Universal Serial Bus (USB) standard. The invention has particular although not exclusive relevance to securely transferring files between computers using a USB device.

In a typical home or office environment it is relatively easy to copy files from one computer to another. Files can be transferred in a number of ways, such as by creating a physical copy on a DVD or USB memory stick, using networked solutions involving servers/Network Attached Storage (NAS) devices, via network shared drives, and/or cloud services. However, if the data to be copied contains sensitive information or if one of the computers involved (i.e. either the source or the destination computer) cannot be trusted on a network, then the number of possible ways to transfer files is limited considerably.

A common way to transfer sensitive information in a security sensitive environment is to write the data to be transferred to an encrypted mass storage device (such as an encrypted disc (CD/DVD/Blu-ray disc), an encrypted portable hard drive, an encrypted USB drive, and/or the like), and to read/copy the contents of the encrypted mass storage device at the destination.

However, there are a number of drawbacks associated with the above approach including, for example:
encryption at the source and decryption at the destination require additional software (such as “BitLocker To Go” and/or the like), which needs to be installed and configured on both the source and destination computers;
compatible encryption software might not be available on all operating systems
the copied files remain stored on the mass storage device after use; and
there is no simple mechanism for ensuring that the files are transferred (or shared) between the desired computers/devices only.

The inventors have realised that there is a need to provide an improved method of providing secure file transfer, associated apparatus, that does not require any (or that requires only a minimal amount of) configuration by the end user.

Accordingly, preferred embodiments of the present invention aim to provide methods and apparatus which address or at least partially deal with the above issues.

Although for efficiency of understanding for those of skill in the art, the invention will be described in detail in the context of a USB device, the principles of the invention can be applied to other types of connectors/interfaces via which two or more computers (and/or other communication devices) connect to each other, either wirelessly or via an appropriate cabled connection.

In one aspect, the invention provides apparatus for facilitating secure data transfer between two data processing devices, the apparatus comprising: means for connecting to a first data processing device via a first interface; means for receiving data from said first data processing device via said first interface; means for storing said data received from said first data processing device in a data store; means for connecting to a second data processing device via a second interface; and means for providing said stored data to said second data processing device via said second interface; wherein said apparatus is operable to render said stored data unreadable to either data processing device upon disconnection from at least one of said first data processing device and said second data processing device.

The apparatus might comprise means for encrypting said data received from said first device and said means for storing said data might be operable to store said data in an encrypted form.

The apparatus might be operable to render said data unreadable by deleting a key associated with said encrypted data. For example, the apparatus might be operable to store said key in random access memory (RAM) key store whereby said key might be deleted from said RAM key store when power to said RAM key store is removed.

The apparatus might be operable to render said data unreadable by at least one of reformatting, overwriting and deleting said stored data.

The means for storing said data received from said first data processing device might be operable to store said data in a random access memory (RAM) data store whereby said apparatus might be operable to render said data unreadable by virtue of said data being deleted from said RAM data store when power to said RAM data store is removed.

The apparatus might further comprise means for automatically (re)formatting said data store on at least one of: connection via at least one of said first and second interface; and disconnection of at least one of said first and second interface;

whereby to render any data stored therein on said connection or disconnection unreadable.

The at least one of said first and second interfaces might comprise a Universal Serial Bus (USB) interface. In this case, the apparatus might be integrated with a USB cable.

The means for connecting to a first data processing device via a first interface and said means for connecting to a second data processing device via a second interface might be provided in a common processing entity.

The means for connecting to a first data processing device via a first interface might be provided in a first processing entity, the means for connecting to a second data processing device via a second interface might be provided in a second processing entity, and said first and second processing entities might be operable for communication with one another to facilitate provision of said stored data to said second data processing device.

The first and second processing entities might be operable for communication with one another via a wireless link (e.g. Wi-Fi and/or Bluetooth). The first and second processing entities might be operable for communication with one another via a wired link (e.g. a Universal Serial Bus link). The first and second processing entities might be operable for communication with one another via an optical link.

The first and second processing entities each might have a respective data store for storing said data. In this case, the first and second processing entities might be each operable to store said data in their respective data store in an encrypted form and said first and second processing entities might be operable for communication with one another to exchange a key associated with encryption of said encrypted data.

The first and second processing entities might be operable for communication with one another to render said stored data unreadable via said first or said second interface.

The first and second processing entities might be operable to be uniquely paired with one another whereby to inhibit communication with another similar processing entity.

The apparatus might be operable, in at least one configuration, to allow transfer of said data in one direction and to inhibit transfer of said data in the other direction. In this case, the apparatus might be operable to allow transfer of said data in one direction and to inhibit transfer of said data in the other direction by virtue of one of said first and second interfaces being configured to be a read only interface. The apparatus might be operable to allow transfer of said data in one direction and to inhibit transfer of said data in the other direction for a predetermined time period. The apparatus might be operable to start the predetermined time period when a write operation is performed via one of said first and second interfaces, and to inhibit a write operation via the other of said first and second interfaces, until expiry of said predetermined time period.

The apparatus might comprise an optical link via which said data is transferred and said apparatus might be operable to allow transfer of said data in one direction and to inhibit transfer of said data in the other direction by virtue of a unidirectional optical element.

The apparatus might be operable, in at least one configuration, for transfer of said data bidirectionally. The apparatus might be operable for transfer of said data unidirectionally or bidirectionally depending on configuration.

In one aspect, the invention provides a system comprising the above described apparatus and at least one data processing device.

In one aspect, the invention provides a method performed by the above described apparatus, the method comprising: connecting said apparatus to said first data processing device via said first interface; connecting said apparatus to said second data processing device via said second interface; receiving data from said first data processing device via said first interface when a connection to said first data processing device via said first interface has been made; storing said data received from said first data processing device in said data store; providing said stored data to said second data processing device via said second interface; and rendering said stored data unreadable to either data processing device upon disconnection from at least one of said first data processing device and said second data processing device.

Aspects of the invention extend to computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Embodiments of the invention will now be described, by way of example, with reference to the accompanying drawings in which:

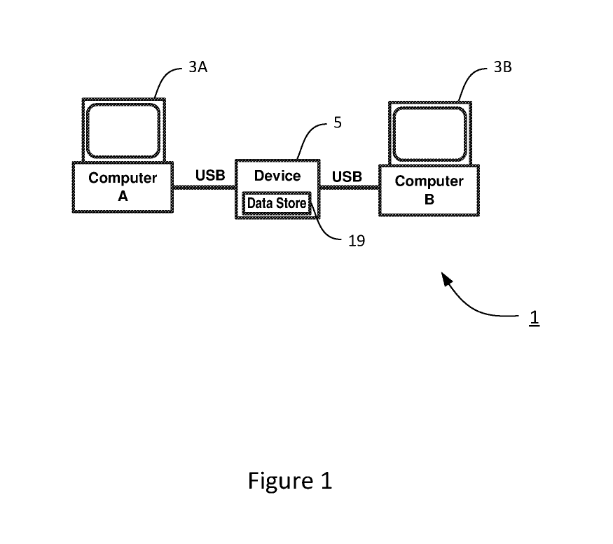

FIG. 1 illustrates schematically a secure data transfer system;

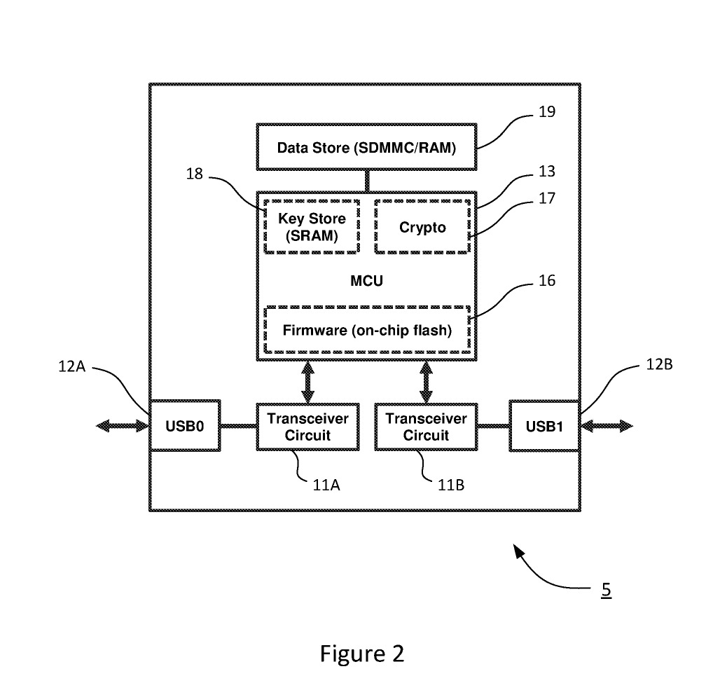

FIG. 2 is a block diagram of a secure data transfer device forming part of the system shown in FIG. 1;

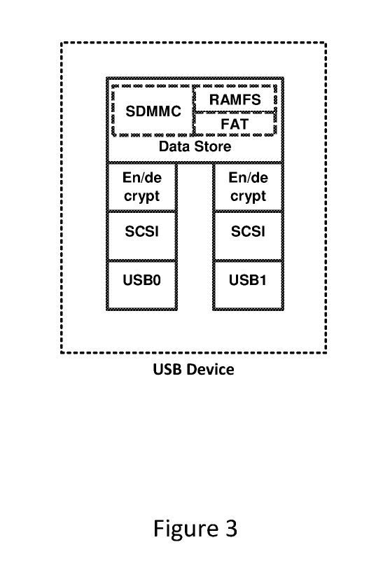

FIG. 3 is an exemplary protocol stack of the secure data transfer device shown in FIG. 1;

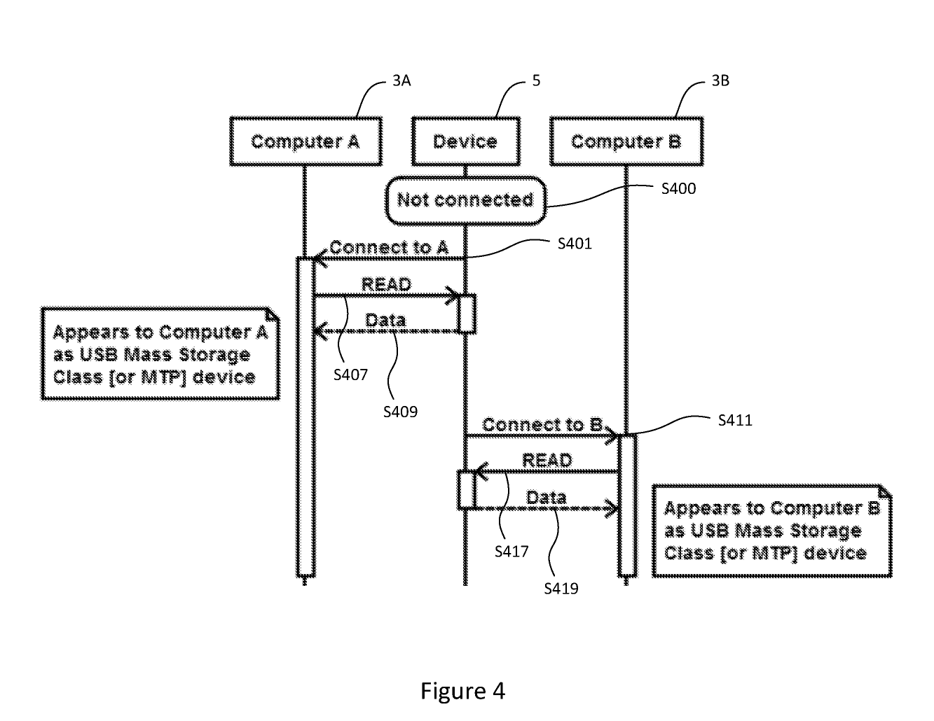

FIG. 4 is an exemplary timing diagram illustrating a method carried out by components of the system shown in FIG. 1 during a connection phase;

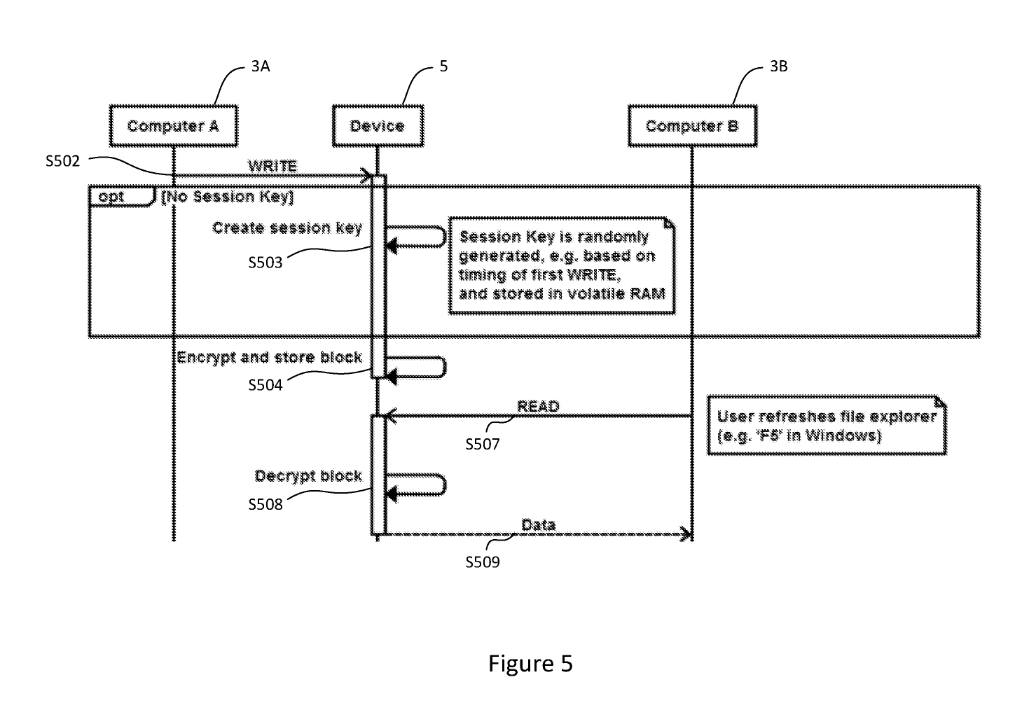

FIG. 5 is an exemplary timing diagram illustrating a method carried out by components of the system shown in FIG. 1 during a secure data transfer session;

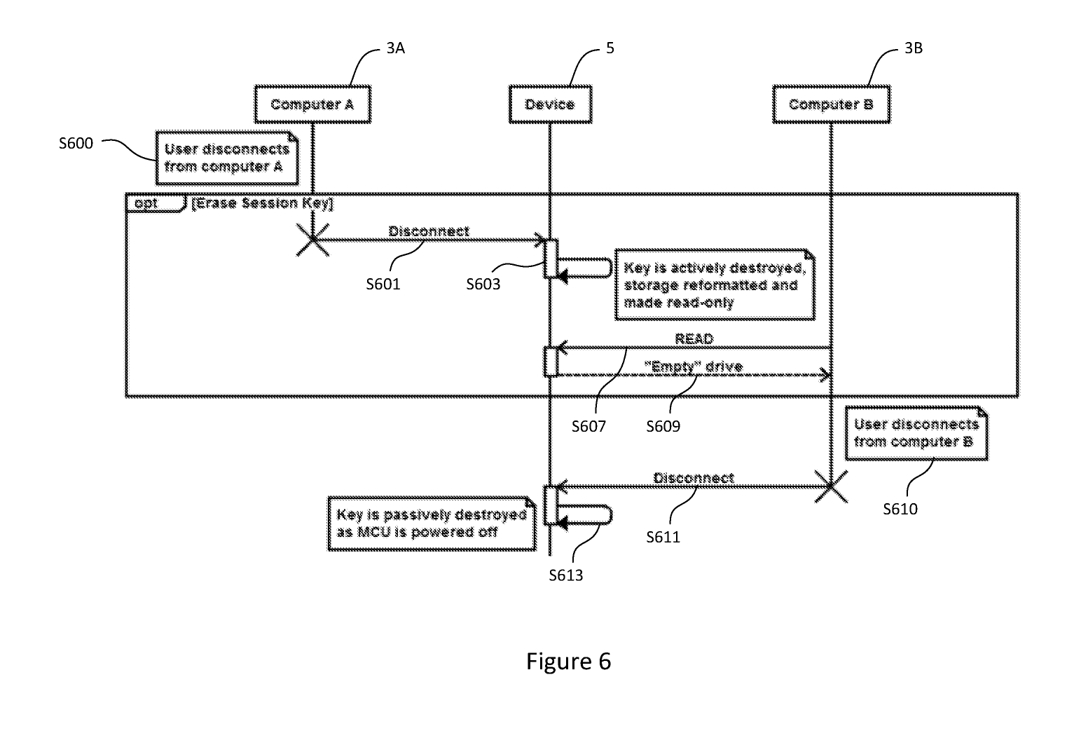

FIG. 6 is an exemplary timing diagram illustrating a method carried out by components of the system shown in FIG. 1 when terminating a secure data transfer session;

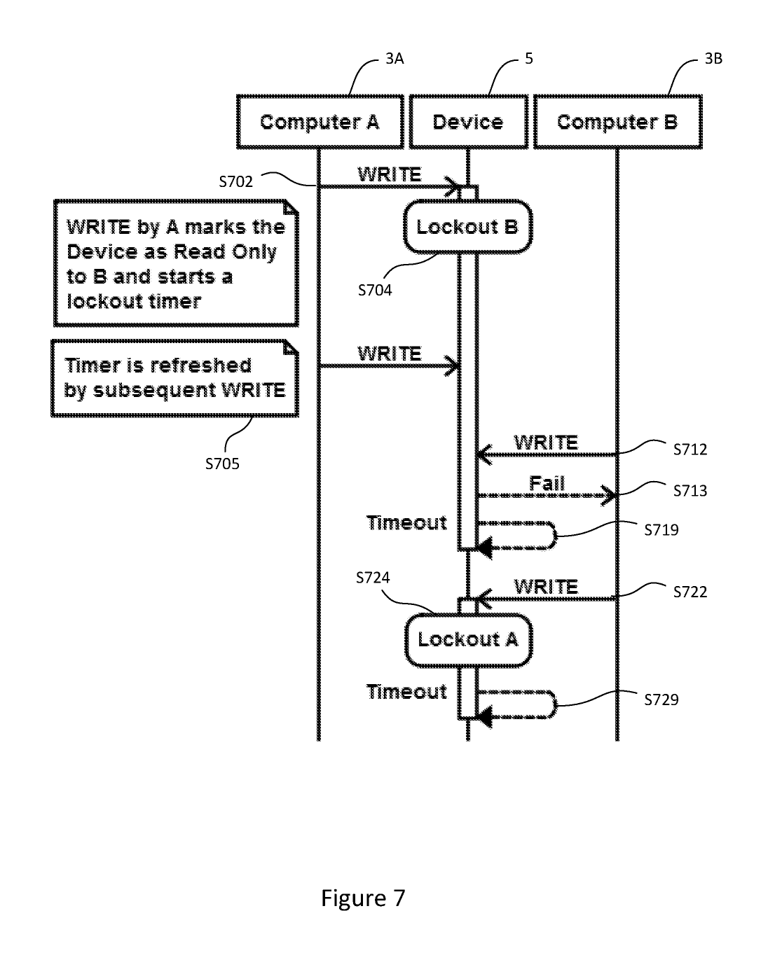

FIG. 7 is an exemplary timing diagram illustrating a method carried out by components of the system shown in FIG. 1 whilst performing a lockout function;

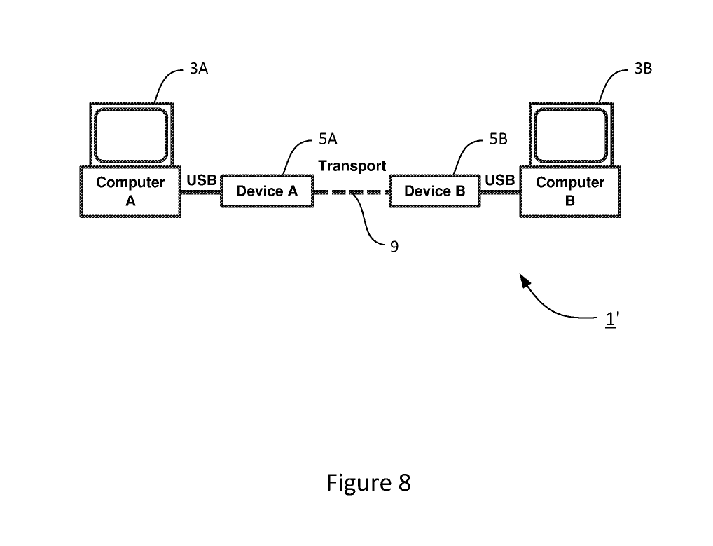

FIG. 8 illustrates schematically another secure data transfer system;

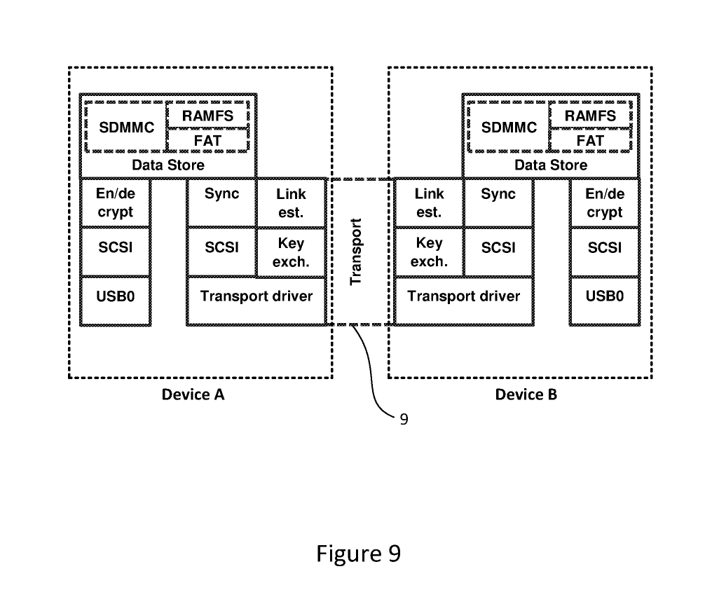

FIG. 9 is an exemplary protocol stack of the secure data transfer device shown in FIG. 8; and

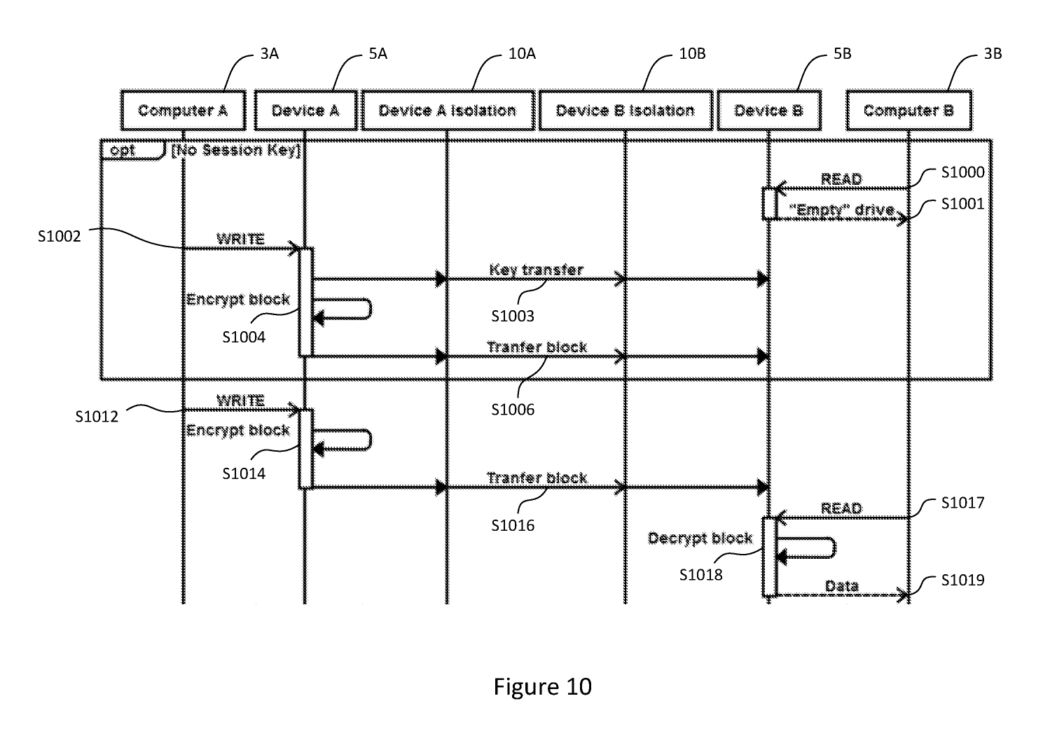

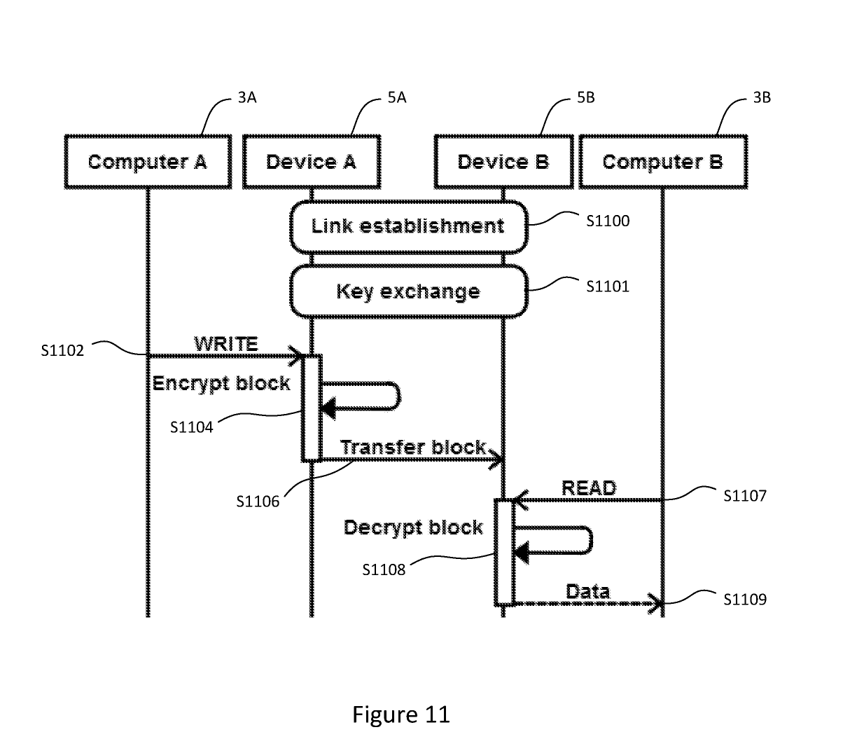

FIGS. 10 and 11 are exemplary timing diagrams illustrating various methods carried out by components of the system shown in FIG. 8.

### OVERVIEW

FIG. 1 schematically illustrates a communications system 1 in which data can be communicated securely between a first computer 3A and a second computer 3B via a file transfer device 5. In this example, the computers each comprise personal computers although it will be appreciated that they may comprise any other types of computing and/or communication devices (such as laptop computers, tablet computers, mobile telephones, servers, hard drives, televisions, and/or the like) which can communicate with other such devices.

Specifically, in this example, the first computer 3A (e.g. an untrusted computer) comprises a file that needs to be securely transferred onto the other computer 3B (e.g. a trusted computer). As can be seen, each computer 3 is connected to the file transfer device 5 via an appropriate wired connection (in this example, via a USB connection).

The file transfer device 5 may be powered from either USB port. Once connected, the file transfer device 5 is seen by both computers 3 as a standard Mass Storage Class (MSC) device although, optionally, the file transfer device may also be seen as a Media Transfer Protocol (MTP) device and/or other generic USB device. Beneficially, the computers 3 might be able to use their native drivers (e.g. MSC/MTP drivers, which are included on Windows, OS X, and Linux computers by default) so that there is no need to install any special, proprietary driver and/or application software on the computers 3 to enable them for communication with the file transfer device 5.

The file transfer device 5 includes a data store portion 19 for storing data. Effectively, the file transfer device 5 implements a shared file system for the connected computers 3. In other words, the file transfer device 5 emulates the look-and-feel of a typical USB thumb drive. Thus, the file transfer device 5 has typical physical dimensions similar to a USB thumb drive or a Wi-Fi dongle. Beneficially, the file transfer device 5 becomes operative in a relatively short time (e.g. within a few seconds) after being plugged in to a computer 3.

In this example, the user first connects the file transfer device 5 to the first computer 3A and then to the second computer 3B. It will be appreciated, however, that the sequence of connection does not affect the operation of the file transfer device 5. The file transfer device 5 appears as a conventional USB storage device to both computers 3A, 3B. Initially, when the file transfer device 5 is connected to the computers 3, the data store portion 19 appears to both computers 3 as an empty pre-formatted file system (e.g. a FAT file system and/or the like) and either computer 3A, 3B can write files to the file transfer device 5 the same way as they would write files to any other USB drive.

However, in this case, the files written on the file transfer device 5 (i.e. to the data store portion 19 thereof) are encrypted by the file transfer device 5 on the fly. Thus, the encrypted data store portion 19 facilitates secure data transfer between the connected computers 3A, 3B, because both computers 3A, 3B can access the data store portion 19.

Specifically, in this example, the first computer 3A copies (or moves) a number of files to the file transfer device 5. The file transfer device 5 is configured to (automatically) encrypt the files and store the encrypted files in the data store portion 19. The data store portion 19 and any (encrypted) data stored therein can be accessed via either USB connection (i.e. by both computers 3A and 3B). Thus, the files written by the first connected computer 3A can be accessed and read by the other connected computer 3B (and vice versa), assuming that both computers 3A, 3B are connected to the file transfer device 5. In order to ensure that the files (which are stored in the data store portion 19 in an encrypted format) can be read by the other connected computer 3B, the file transfer device 5 is configured to decrypt the files (on the fly) upon either one of the connected computers (in this example, computer 3B) attempting to read the files.

Thus, beneficially, there is no need for either connected computer 3A, 3B to implement any file encryption/decryption functionality in order to provide a secure link between the two computers. Both computers are able to access the data store portion 19 of the file transfer device 5, which stores data securely, and prevents any other computer or device other than the connected computers 3 from being able to access the data.

Beneficially, when the file transfer device 5 is disconnected from either computer 3, the files stored in the data store portion 19 are rendered unreadable (so that the ‘drive’ will appear empty again when it is subsequently re-connected to a pair of computers, even if they are the same computers 3A, 3B). When file transfer device 5 is disconnected from either computer 3A or 3B (e.g. or when either computer ejects/unmounts/unplugs/deactivates the file transfer device 5), then the part of the file transfer device's 5 data store portion 19 holding the encrypted files and/or a memory portion holding the associated encryption key(s) is erased locally. Further, the file transfer device 5 may also be configured to perform a quick-format of the data store portion upon powering down (and/or upon subsequently powering up) the file transfer device 5 to prevent any unauthorised access to the contents of the data store portion 19.

Beneficially, in one example, the data store portion 19 comprises non-persistent memory, which ensures that the contents of the encrypted data storage are in effect “erased” upon powering off the file transfer device 5 (and/or upon disconnecting the file transfer device 5 from its power source). Therefore, even if the file transfer device 5 is misplaced, it is not possible to recover any data previously stored in the data store portion 19 of the file transfer device 5. It will be appreciated that only the memory portion that holds the associated cryptographic keys may be non-persistent in which case that the contents of the main data store carrying any encrypted files will become unreadable (and will in effect have been “erased”) upon powering off the file transfer device 5 because any such files would appear as random data without the associated cryptographic keys.

In summary, depending on its configuration, the file transfer device 5 offers one or more of the following benefits:
security: data copied to the file transfer device 5 is only shared with the computers 3 connected to the file transfer device 5;
security: the session key is not shared with either computers 3A, 3B;
non-persistent: after use, transient (readable) copies are not kept on the file transfer device 5 and thus it is not possible to recover the shared information after the file transfer device 5 has been disconnected from the source and/or destination computers;
driver-free: the file transfer device 5 announces itself to the computers 3 as a USB device (e.g. an MSC device), which is supported by all major operating systems;
familiarity: since users are familiar with the concept of USB mass storage, the way the file transfer device 5 works is familiar to them and offers a similarly seamless way with the additional benefit of being more secure than conventional USB mass storage devices; and
ease of use: since users are also familiar with the concept of ad-hoc networking, the idea that both ends of the cable need to be connected in order to facilitate data transfer is not likely to cause difficulty in using the file transfer device 5.

### File Transfer Device

FIG. 2 is a block diagram illustrating the main components of the file transfer device 5 shown in FIG. 1. As shown, the file transfer device 5 has a first transceiver circuit 11A that is operable to transmit signals to and to receive signals from the first computer 3A (via a first USB port 12A) and a second transceiver circuit 11B that is operable to transmit signals to and to receive signals from the second computer 3B (via a second USB port 12B). It will be appreciated that whilst the first and second transceiver circuits 11 are shown separately in FIG. 2, they may be combined as a single transceiver circuit, if appropriate.

The file transfer device 5 has a controller 13 (e.g. a microcontroller unit) to control the operation of the file transfer device 5. The controller 13 is associated with a memory and is coupled to the transceiver circuits 11. Software may be pre-installed in the memory and/or may be downloaded via a communications network or from a removable data storage device (RMD), for example.

The controller 13 is configured to control the overall operation of the file transfer device 5, by, in this example, program instructions or software instructions stored within the memory. As shown, these software instructions include, among other things, a firmware 16 (and/or an operating system), a cryptographic module 17, and a key storage module 18.

The file transfer device 5 also includes a data store portion 19 for securely storing data to be transferred via the file transfer device 5 between the connected computers 3A, 3B. Preferably, the data store portion 19 comprises volatile memory, such as a Random Access Memory (RAM), Dynamic RAM (DRAM), and/or the like, although it may also comprise non-volatile memory, such as Flash or Secure Digital (SD) based memory and/or the like.

The firmware 16 controls the communication between the file transfer device 5 and other devices, such as the computers 3A and 3B (when connected to the file transfer device 5), including handling of writing data to and reading data from the data store portion 19. The firmware 16 also enforces access rights to the data store portion 19 for the connected devices, for example, by preventing one device from writing to the data store portion 19 whilst another device is also writing to the data store portion 19. Effectively, the firmware enforces that an appropriate access control configuration is in place between the two connected devices (e.g. computers 3A and 3B).

The cryptographic module 17 carries out an appropriate encryption of data (e.g. files) being written to the data store portion 19 and an appropriate decryption of data being read from the data store portion 19.

The key storage module 18 comprises a memory (preferably a volatile memory) for storing an associated cryptographic key used by the cryptographic module 17 in its operation. It will be appreciated that the key storage module 18 may be configured such that it is only accessible for the other modules whilst there is a respective device connected to both the first USB port 12A and the second USB port 12B.

In the above description, the file transfer device 5 is described for ease of understanding as having a number of discrete modules (such as the cryptographic module 17 and the key storage module 18). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

### Protocol Stack

FIG. 3 is an exemplary protocol stack of the secure file transfer device 5 shown in FIG. 1.

As can be seen, the lowest layer of the protocol stack comprises a USB layer which provides a physical layer connection towards the first and second computers 3 via the corresponding USB ports (denoted ‘USB0’ and ‘USB1’, respectively).

The second layer from the bottom comprises a Small Computer System Interface (SCSI) layer which handles messages relating to the read and write operations (and enforcing access rights, when appropriate) by the connected computers 3. For example, the SCSI layer is operable to send/receive appropriately formatted SCSI messages when one of the computers attempts to write data to the data store portion 19 of the data transfer device 5 (‘SCSI WRITE’ message) and/or read data from the data store portion 19 of the data transfer device 5 (‘SCSI READ’ message).

The next layer comprises an encryption/decryption layer, which ensures that: any data is encrypted before being written to the data store portion 19; and any encrypted data stored in the data store portion 19 is decrypted before being transmitted to the computer 3 that performs an appropriate read operation (e.g. an ‘SCSI READ’ operation). The encryption/decryption layer is controlled by the cryptographic module 17.

The top layer of the file transfer device 5 comprises the data store layer, which controls the operation of the data store portion 19. As can be seen, the data store layer includes associated file system features, such as a File Allocation Table (FAT), a RAM File System (RAMFS), and/or a secure digital (SD) multi-media card (MMC) protocol. It will be appreciated that either one (or more) of the FAT, RAMFS, and SDMMC protocol are optional.

### Operation

A more detailed description will now be given (with reference to FIGS. 4 to 7) of various aspects of the operation of the file transfer device 5 and connected devices when securely transferring data (e.g. sensitive files) between the computers 3A and 3B.

### Initial Connection

FIG. 4 is an exemplary timing diagram illustrating a method carried out by components of the system 1 shown in FIG. 1 during a connection phase.

As generally illustrated at step S400, the file transfer device 5 is initially not connected (not plugged in) to either computers 3A or 3B.

Upon connecting the file transfer device 5 to the first computer 3A, in step S401, the file transfer device 5 (its data store portion 19) appears to the computer 3A as an external drive (e.g. as a USB MSC or a USB MTP device). Therefore, when the first computer 3A attempts to access the contents of the data store portion 19, the computer 3A generates and sends, in step S407, an appropriately formatted command (for example, an SCSI ‘READ’ command and/or the like) to read or list the contents of the data store portion 19. In response to the computer's 3A command, the file transfer device 5 returns, in step S409, information relating to the data stored in the data store portion 19.

Similarly, when the file transfer device 5 is connected to second first computer 3B as well, as generally shown in step S411, the file transfer device 5 (its data store portion 19) appears to the computer 3B as an external drive. Thus, upon receiving, in step S417, an appropriately formatted command (for example, an SCSI ‘READ’ command and/or the like) from the second computer 3B for reading the contents of the data store portion 19, the file transfer device 5 returns, in step S419, to the second computer 3B information relating to the data store portion 19.

It will be appreciated that the data store portion 19 is initially empty, hence the file transfer device's 5 response to the computers 3 (at step S409 and S419) indicates that the external drive is empty. The response at step S409/S419 may also include information identifying an available (remaining/allocated) capacity of the data store portion 19 and/or information identifying access rights (e.g. master/slave mode and/or RW/RO access) currently allocated to that computer 3A/3B.

Beneficially, the connection between the two computers 3A, 3B in this case is similar to connecting computers using an Ethernet cable, although there is no need for the user to configure either computer 3A or 3B (or the file transfer device 5) for communication with each other.

### File Transfer Session

FIG. 5 is an exemplary timing diagram illustrating a method carried out by components of the system shown in FIG. 1 during a secure data transfer session. In this example, a file is being transferred securely from the first computer 3A to the second computer 3B.

As can be seem, the file transfer operation begins at step S502, in which the first computer generates and sends an appropriately formatted command (for example, an SCSI ‘WRITE’ command and/or the like) to write data to the data store portion 19.

In step S503, e.g. in response to the computer's 3A (first) write command, the file transfer device 5 (using its cryptographic module 17) creates an appropriate cryptographic key (i.e. a session key and/or the like). As can be seen, step S503 is optional and may be only performed initially, for example when one of the computers 3A, 3B first attempts to write data to the data store portion 19. The generated cryptographic key is stored in the key store module 18 (thus, preferably, the cryptographic key does not form part of the data written by the first computer 3A to the data store portion 19).

As generally indicated in step S504, the file transfer device 5 (using its cryptographic module 17) performs an appropriate encryption of the data being written to the data store portion 19. Accordingly, the files written by the first computer 3A are stored in the data store portion 19 in an encrypted format.

Next, the second computer 3B generates and sends, in step S507, an appropriately formatted command (for example, an SCSI ‘READ’ command and/or the like) to retrieve the data stored in the data store portion 19. Therefore, the file transfer device 5 (using its cryptographic module 17) decrypts the file (or files) to be retrieved by the second computer 3B, in step S508, and in step S509, it sends the decrypted data (i.e. the file written by the first computer 3A in step S502) to the second computer 3B. It will be appreciated that prior to the second computer 3B to be able to see and access the files stored in the data store portion 19 in step S504, the user of the second computer 3B may need to refresh the contents of the data store portion 19 shown on the screen of that computer 3B.

### Session Termination

FIG. 6 is an exemplary timing diagram illustrating a method carried out by components of the system shown in FIG. 1 when terminating a secure data transfer session.

In step S600, the user disconnects the file transfer device 5 from the first computer 3A. This may be achieved in a number of ways, including for example: by unmounting from the computer 3A the external drive represented by the data store portion 19 of the file transfer device 5; by ejecting/unplugging the file transfer device 5; and/or by powering off the first computer 3A.

In this case, disconnecting the first computer 3A results in the file transfer device 5 detecting (using its controller 13) or otherwise obtaining a signal (e.g. from its transceiver circuit 11, USB port 12, and/or from the first computer 3A itself) that the first computer 3A is no longer connected. In response to this, the transfer device 5 proceeds to delete or destroy the session key stored in its key store module 18. For example, the key store module 18 and/or the data store portion 19 may be reformatted and/or overwritten with other data (e.g. random data) to make sure that any previously stored data can no longer be retrieved from the key store module 18 and/or the data store portion 19. It will be appreciated that since the second computer 3B is still connected (and assuming that the file transfer device 5 is powered via the second computer 3B), the cryptographic module 17 may be configured to actively delete or destroy the session key.

Accordingly, upon receiving any subsequent read (or write) request from the second computer 3B, as generally shown in step S607, the file transfer device 5 is configured to return, in step S609, an indication that the data store portion 19 is empty (i.e. there are no files on the external drive represented by the data store portion 19). It will also be appreciated that upon disconnecting the first computer 3A, the file transfer device 5 may be configured to always return an indication that the data store portion 19 is empty, regardless whether or not step S603 has been performed.

In step S610, the user also disconnects the file transfer device 5 from the second computer 3B. Effectively, if the file transfer device 5 does not have its own power source, step S610 causes the file transfer device 5 powering down and being disconnected (step S611) from both computers 3A, 3B. Even if the file transfer device 5 has its own power source, its processor 13 may be configured to power off upon both computers being disconnected.

As generally shown in step S613, any data (e.g. cryptographic key) still stored in the key store 18 (which comprises a volatile memory) is passively destroyed when the processor 13 is powered off, rendering any data remaining in the data store portion 19 unusable (even if the data store portion 19 comprises non-volatile memory) since such data cannot be retrieved in the absence of a corresponding session key.

### Write Lockout

FIG. 7 is an exemplary timing diagram illustrating a method carried out by components of the system shown in FIG. 1 whilst performing a lockout function for controlling access of the connected computers 3 to the data store portion 19.

In this example, the two computers 3 that are connected to the file transfer device 5 are in a master-slave relationship, in which case one computer (in this example, the first computer 3A, i.e. the data source) acts as a master and is able to write data to the file transfer device 5, whilst the other computer (in this example, the second computer 3B, i.e. the data destination) acts as a slave and is only able to read data from the file transfer device 5. However, it will be appreciated that the roles of the master and slave computers 3 may be reversed when appropriate (at least during write operations) so that data can be transferred securely via the file transfer device 5 both ways.

In this example, the file transfer device 5 (its firmware 16) is configured to control access to the data store portion 19 and to grant read/write (R/W) access to the computer acting as the master device, and to grant read-only (RO) access to the computer acting as the slave device. Depending on the implementation, the data store portion 19 might not be visible (or accessible) at the same time to both connected computers 3.

Specifically, once a write operation is encountered, as shown in step S702, the computer 3A that is writing data is set as the master (having R/W access rights for the file transfer device 5) and the other computer 3B is set as the slave (having RO access right), at least for the duration of the write operation. This would beneficially prevent both computers 3A, 3B being able to write to the data store portion 19 at the same time.

Therefore, as generally indicated in step S704, the file transfer device 5 starts an appropriate (pre-configured) lockout timer and starts enforcing an appropriate access restriction (lockout/RO mode operation) for the second computer 3B in order to prevent it from writing to the data store portion 19, at least until the lockout timer is running (although the second computer 3B may still be allowed to read the contents of the data store portion 19 whilst the lockout timer is running).

As shown in step S705, any subsequent write operation, initiated by the same computer 3A before expiry of the lockout timer, causes the file transfer device 5 to refresh (restart) the lockout timer and to continue enforcing the access restriction for the second computer 3B.

Therefore, as generally indicated in steps S712 and S713, if the second computer 3B attempts to write to the data store portion 19 whilst the lockout timer is running, the file transfer device 5 returns an appropriate failure indication (e.g. a ‘Write Fail’ and/or Drive Busy′ indication) to the second computer 3B. It will be appreciated that the file transfer device 5 may be configured to simply ignore the second computer's 3B attempt (at step S712) whilst the lockout timer is running, i.e. without returning any explicit failure indication (thus step S713 is optional).

Upon expiry (step S719) of the lockout timer the file transfer device 5 releases the lockout for the second computer 3B. Therefore, if the second computer 3B attempts again, in step S722, to write to the data store portion 19, the file transfer device 5 allows the write operation and starts an appropriate lockout timer for restricting the first computer's 3A access to the data store portion 19, at least until expiry (step S729) of the lockout timer specific to that computer 3A.

Beneficially, both computer 3A and computer 3B are allowed to write to the file transfer device 5. However, in order to protect the integrity of the data store portion 19, only one computer is allowed to write at a time.

### Dual-Device Configuration

The following is a description (with reference to FIGS. 8 and 9) of a modified file transfer device adapted for secure transfer of data between two computers 3A, 3B.

FIG. 8 illustrates schematically another system 1′ to which this technology may be applied. However, in this example, the first computer 3A and the second computer 3B are connected via two file transfer devices 5A and 5B and an appropriate transport link 9 (wired or wireless) provided between the file transfer devices 5A and 5B. Depending on implementation and/or the use case, the transport link 9 may comprise a unidirectional link or a bidirectional link. The transport link 9 may also comprise an optical link, if appropriate.

As can be seen, similarly the system 1 shown in FIG. 1, each computer is connected to its respective file transfer device via an appropriate wired connection (in this example, via a USB connection). However, the file transfer devices 5A and 5B in FIG. 8 have been adapted to communicate with each other via the transport link 9. Effectively, each file transfer device 5A, 5B is configured to act as a mirror of its peer device 5, i.e. the data held by one file transfer device is substantially identical to the data held by the other file transfer device. Further details of the file transfer devices 5A and 5B will be explained with reference to FIG. 9 below.

### Protocol Stack

FIG. 9 is an exemplary protocol stack of the secure file transfer device 5 shown in FIG. 8. This protocol stack has been adapted to support secure transfer of files between two file transfer devices 5A and 5B (and hence between respective computers 3 connected thereto) that do not need to be co-located.

The layers of the protocol stack that connect to a respective local computer (i.e. the side of the protocol stack about the ‘USB0’ port) correspond to the layers described with reference to FIG. 3, thus they are not described again herein for simplicity.

However, the side of the protocol stack that connects the two transfer devices 5A and 5B is arranged to support an appropriate transport link 9 (e.g. a secure communication link). Specifically, the protocol stack shown in FIG. 9 employs a so-called “Remote SCSI” protocol to provide an appropriate synchronisation between the two file transfer devices 5A, 5B.

As can be seen, the bottom layer towards the transport link 9 comprises a transport driver layer. It will be appreciated that this layer may support any type of communication technology (wired or wireless) that can be used for communicating data between two endpoints (e.g. by way of a secure tunnel and/or the like).

The second layer from the bottom comprises a key exchange layer. The key exchange layer performs functionality related to exchanging the associated cryptographic key(s) (over the transport link 9) between the corresponding key storage modules 18 of the file transfer devices 5A and 5B. Beneficially, such a key exchange makes it possible for one file transfer device 5B to decrypt data/files encrypted by the other file transfer device 5B (and hence to make the decrypted data available to the computer 3B locally connected to that file transfer device 5B). It will be appreciated that each file transfer device 5A/5B may be configured to scan for its peer file transfer device (e.g. upon powering up the file transfer device) and to enable its USB port only after establishing a connection and/or exchanging keys with its peer file transfer device.

On top of the key exchange and SCSI layers towards the transport link 9, an appropriate synchronisation layer and a link establishment layer are provided between the connected file transfer devices 5A and 5B (instead of an encryption/decryption layer).

The synchronisation layer facilitates sharing of status information and mirroring of the actual data (data blocks) stored in the data store portions 19 between the two file transfer devices 5A and 5B. Accordingly, the data storage portions 19 of each file transfer device 5 are kept in sync with each other and each local write operation (by the directly connected ‘local’ computer 3) on one of the file transfer devices 5 is forwarded to the other (remote) file transfer 5 device using the synchronisation layer. Therefore, whenever the second computer 3B initiates a read operation with the file transfer device 5B that it is connected to, the requested data can be fetched directly from the local data store 19 of the file transfer device 5B. Therefore, there is no need to transfer the requested data over the transport link 9 upon the second computer's 3B read attempt (since that data is already synchronised and it is available from the local data store portion 19).

### Unidirectional

FIG. 10 is an exemplary timing diagram illustrating another method carried out by components of the system 1′ shown in FIG. 8. In this example, data transfer is possible only in one direction, from the first computer 3A (coupled to the first file transfer device 5A) to the second computer 3B (coupled to the second file transfer device 5B). The unidirectional feature is achieved by coupling each file transfer device 5 with an appropriate isolation module 10, which allows communication in one direction only. For example, the isolation modules 10 each may comprise a unidirectional data gateway element or a unidirectional data diode (assuming that an optical connection is used between the two file transfer devices 5).

It will be appreciated that in this example the file transfer devices 5A, 5B are configured such that the contents of the data store portion 19 of the first file transfer device 5A are mirrored to the data store portion 19 of the second file transfer device 5B (using the architecture explained above with reference to FIGS. 8 and 9).

As can be seen in FIG. 10, if no session key is available, any attempt by the second computer (step S1000) to access the data store portion 19 of the second file transfer device 5B results in the second file transfer device 5B returning, in step S1001, an appropriate indication that the drive is empty/unavailable.

In this example, a session key is generated upon the first file transfer device 5A writing the first block of data to the data store portion 19 of the first file transfer device 5A. Step S1002 generally corresponds to step S502 (described above with reference to FIG. 5) and hence it will not be described in detail again.

In step S1003, the first file transfer device 5A (using its cryptographic module 17) creates an appropriate cryptographic key (i.e. a session key and/or the like) and transfers the key to the second file transfer device 5B. Step S1004 generally corresponds to step S504, hence its description is omitted herein for simplicity.

In step S1006, the first file transfer device 5A transfers the encrypted data (corresponding to the data written by the first computer in step S1002) to the second file transfer device 5B. As can be seen, steps S1002, S1004, and S1006 are repeated (denoted steps S1012, S1014, and S1016, respectively) whenever the first file transfer device 5A writes data to the data store portion 19 of the first file transfer device 5A.

Effectively, steps S1012 to S1016 result in the contents of the data store portion 19 of the first file transfer device 5A being mirrored by the data store portion 19 of the second file transfer device 5B.

Therefore, when the second computer 3B subsequently attempts to access the data store portion 19 of the second file transfer device 5B, as shown in step S1017, the second file transfer device 5B is able to return, in step S1019, the data (transferred files) requested by the second computer 3B (after an appropriate decryption, illustrated in step S1018).

It will be appreciated that the first file transfer device 5A may also be configured to send, e.g. in step S1016, an associated MD5/SHA2 hash (and/or the like) in order to ensure data integrity. Similarly, the second file transfer device 5B may also be configured to send such an associated MD5/SHA2 hash (and/or the like), for example, to confirm receipt of the transferred file(s) by the second file transfer device 5B.

### Wireless

FIG. 11 is an exemplary timing diagram illustrating another method carried out by components of the system 1′ shown in FIG. 8. In this example, data transfer between the first computer 3A (coupled to the first file transfer device 5A) and the second computer 3B (coupled to the second file transfer device 5B) is realised using an appropriate wireless link (between the file transfer devices 5A and 5B).

In this example, the wireless link comprises a suitable radio frequency link (either unidirectional or bidirectional) using, for example, Wi-Fi, Bluetooth, and/or other equally fast wireless protocols.

Initially, the file transfer devices 5A and 5B establish a wireless link, in step S1100. In step S1101, the file transfer devices 5A and 5B perform an appropriate key exchange procedure in order to secure communications over the wireless link between the file transfer devices 5A and 5B. It will be appreciated that the key(s) for securing the wireless link may be different to the session key used to encrypt the data store portions 19.

The data is initially received (in step S1102) and encrypted (in step S1104) by the master device (in this example, the first file transfer device 5A) for storing in its data store portion 19. Next, the data is synchronised (in step S1106) to the slave device (in this example, the second file transfer device 5B) and made available to the second computer 3B (operating in slave mode) coupled to the second file transfer device 5B.

It will also be appreciated that a per-device pair configuration may be preloaded into the file transfer devices 5A and 5B (which cannot be modified by the user) in order to prevent pairing of arbitrary file transfer devices and also to prevent eavesdropping of the wirelessly transmitted data by untrusted file transfer devices and/or computers.

### Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

It will be appreciated that the computers 3 may be connected to the file transfer device 5 either simultaneously or sequentially (e.g. the first computer 3A may be connected for writing a file to the transfer device 5 regardless whether the second computer 3B is connected or not; and the second computer 3B may be connected for reading that file from the transfer device 5 regardless whether the first computer 3A is connected or not).

Whilst in the example described with reference to FIG. 1, the computers 3 are connected to the file transfer device 5 using an appropriate USB cable. However, it will also be appreciated that the computers 3 may be connected to the file transfer device 5 using a different type of cable and/or a different interface (e.g. UTP, FireWire, RS-232, IP, phoneline, and/or the like). It will also be appreciated that each of the computers 3 may be connected to the file transfer device 5 using a different connection type. Further, it will also be appreciated that the either one (or both) of the computers 3 may be connected to the file transfer device 5 using a wireless connection rather than USB.

It will be appreciated that the secure file transfer device 5 may be provided as a device forming part of the cable (e.g. an appropriate USB cable) connecting the computers 3A and 3B. However, it will also be appreciated that the file transfer device 5 may be implemented as a standalone device (e.g. without including a cable) or as part of another device (e.g. as part of a communication controller thereof). For example, such a file transfer device 5 may be implemented as part of a computer 3, a hub, bridge, router, server, and/or the like.

In the above description, a master-slave relationship is described to be in place during write operations, which may be altered between the connected computers 3 in dependence on which computer is writing data onto the file transfer device 5. However, it will also be appreciated that such a master-slave configuration may be predetermined and preloaded into the memory of the file transfer device 5 and cannot be modified by the user. In this case, one of the computers 3 (or USB ports) may be permanently configured to operate in R/W mode and the other computer (or USB port) may be configured to operate in read-only mode, thus effectively resulting in a one-way file transfer device.

It will also be appreciated that the file transfer device 5 might be configured to prevent any auto-run features to be used on either computer 3 (e.g. upon connecting the file transfer device 5 to either computer 3). For example, some operating systems may be configured to test the write speed of a newly plugged in storage device by writing some blocks. However, the file transfer device 5 may be configured to recognise such test write attempts and to discard them for the file transfer device's 5 normal operation (e.g. encryption, lock-out, changing master-slave mode of operation, etc.).

It will be appreciated that the file transfer device 5 may generate a session key (thus step S503 may be performed) even before step S502, for example, when the computers 3A, 3B are first connected to the file transfer device 5. Therefore, step S503 may be performed as part of step S401, S411, and/or any other step preceding (or including) step S502. It will also be appreciated that step S503 may be repeated, i.e. a new session key may be generated, whenever there is no valid session key in the key store module 18 (e.g. because the key has expired and/or one of the computers 3A, 3B is no longer connected to the file transfer device 5).

It will be appreciated that the session key may be generated randomly, for example, the key may be based on the time of the first write and/or the time of the first connection between the file transfer device 5 and one or both of the computers 3A, 3B.

Further, in the case of a master/slave architecture, it will be appreciated that the slave device may delay asserting itself via the USB port 12 until the master is ready to share the data (e.g. at least until the storing of the encrypted file is completed in step S504).

It will be appreciated that, as an additional security measure, the file transfer device may be powered from the target computer. This would prevent the source computer from writing any data to the data store portion until both computers are connected.

In the above description, the computer is described to write data to the file transfer device using a suitable SCSI ‘WRITE’ command. It will be appreciated that data writing may also be implemented in either one (or both) of the following ways:
1) The file transfer device 5 may be configured to interpret block writes (performed by the master computer) as FAT operations, parse directory entries, and identify file length and content. Using this approach, the file transfer device 5 is able to identify when a file is completely written into the data store portion 19 and transfer the file (or make that file available) to the slave device (i.e. the second computer 3B or the second file transfer device 5B coupled to the second computer 3B) without delay. In this case, a lockout timer may not be required.
2) The file transfer device 5 may be configured not to interpret the data included in the block writes (by the master computer 3A). Instead, the file transfer device 5 may be configured to transfer the content of its data store portion 19 (either the whole content or at least any changed bits) to the slave device (i.e. the second computer 3B or the second file transfer device 5B coupled to the second computer 3B) after it has detected termination of the operations (e.g. when the user ejects the file transfer device from the source computer 3A). This approach beneficially gives the user (and the operating system running on the source computer 3A) more freedom to organise the data written to the file transfer device 5 and requires less intelligence in the firmware 16 of the file transfer device 5. For example, the user may be able to re-format the data store portion 19 and/or to use encrypted loop-back devices for additional security.

It will be appreciated that the above options 1) and 2) may also be applicable to implement data mirroring in the examples involving two file transfer devices.

The present USB specification allows three different types of USB mass storage protocols:
Control Bulk Interrupt (CBI): primarily intended for USB floppy drives;
Bulk Only Transport (BOT or BBB): the most common protocol for USB mass storage devices; and
USB Attached SCSI (UAS): this protocol was introduced with USB 3.0 and can be used with USB 2.0 devices onwards. However, UAS is not as widely supported as other protocols.

It will be appreciated that any of the above USB protocols may be used by the above described file transfer device 5, with the BOT/BBB protocol being the most suitable candidate.

It will be appreciated that the controller 13 may comprise an ARM Cortex (e.g. M3 or M4) processor and/or similar. If FAT file system is used, the upper limit for the data store portion 19 may be limited by the FAT file system (2 or 16 TB for FAT32, depending on the block size, or 4 GB for FAT16). If a higher storage capacity is required, then the file transfer device 5 may use e.g. flash memory and/or similar. It will be appreciated that a brown-out detection mechanism may be used for overwriting the session key upon the file transfer device 5 being physically unplugged from the host computer 3 without being ejected/unmounted (via an appropriate software command).

In the above description of FIG. 9, a ‘Remote SCSI’ protocol is used over the transport link 9 in order to facilitate maintaining an appropriate synchronisation between connected file transfer devices operating in the dual-device configuration mode. It will be appreciated that such a Remote SCSI protocol may be implemented using a simple wrapper around regular SCSI commands (and/or including some additional commands, if appropriate). It will be appreciated that the Remote SCSI protocol may be adapted to work on a block level and may not require the firmware to have any knowledge on the content of the data being transferred over the transport link 9.

Most SCSI commands are blocking, that is, a host is required to wait for an appropriate response from the SCSI device before sending a new command. Therefore, some SCSI commands may not need to be forwarded between the file transfer devices 5, for example, if the data required for an appropriate response can be found in the local file transfer device 5. Beneficially, by handling commands locally, it is possible to reduce the time that the connected computer is required to wait for a response before it is able to send a new command. This may also result in an overall smoother user experience when using such a dual-device configuration.

In any case, it will be appreciated that those file transfer devices that are operating in the dual-device configuration mode may need to be able to handle the following SCSI commands (and associated responses) over the network:
SCSI_CMD_VVRITE_10
SCSI_CMD_START_STOP_UNIT

It will be appreciated that the following commands may be handled locally, provided that the two file transfer devices share their status with each other:
SCSI_CMD_READ_10
SCSI_CMD_INQUIRY
SCSI_CMD_READ_CAPACITY_10
SCSI_CMD_SEND_DIAGNOSTIC
SCSI_CMD_MODE_SENSE_6
SCSI_CMD_TEST_UNIT_READY

This command may be sent to by the first file transfer device to the remote (second) file transfer device. Since this command happens periodically, but not too often (typically once every second) it might serve as a keep-alive mechanism over the wireless link.
SCSI_CMD_REQUEST_SENSE
SCSI_CMD_PREVENT_ALLOW MEDIUM REMOVAL
SCSI_CMD_VERIFY_10

The following commands (which are not currently part of the SCSI specifications) may also need to be implemented by file transfer devices operating in the dual-device configuration mode:
EXTRA_CMD_HANDSHAKE—to perform an appropriate handshake and/or key exchange mechanism.
EXTRA_CMD_SHUTDOWN—to indicate that the peer file transfer device has been ejected and/or it is no longer operative. This command may be used to trigger a destruction of the locally stored keys and/or data by the file transfer device. It will be appreciated that instead of such an explicit ‘shutdown’ indication, an appropriate timeout mechanism may also be used. In this case, the peer file transfer device may be assumed to have been shut down (or disconnected) if the local file transfer device fails to receive a keep-alive frame/signal before expiry of an associated timer.

It will be appreciated that the file transfer devices operating in the dual-device configuration mode may be pre-configured by default so that there is no need to the user to configure the file transfer devices to be able to communicate with each other. It will also be appreciated that the file transfer devices operating in wireless mode may be pre-paired by default. For example, one or more of the following parameters may be configured for each wireless file transfer device by default:
the role of the device (e.g. master or slave mode);
a device ID (e.g. a MAC address in case of Wi-Fi);
a network ID (e.g. an SSID in case of Wi-Fi); and
a pre-shared key.

Such factory configuration may be kept in a non-volatile memory on the device, e.g. separately from the firmware code.

Regarding the typical operating range of the file transfer device, it will be appreciated that a wired solution is expected to work in the range of a few metres. Specifically, the current USB specification limits the length of a cable between full speed (or high speed) USB devices to 5 metres, which would allow a “bulge-in-the-wire” type of file transfer device to operate over a maximum of 10 metre range. However, it will be appreciated that in practise the “bulge” is likely be provided at one end of the cable and the cable would typically be in the order of 3 metres.

The operating range of the wireless solution depends on many factors affecting the propagation of radio signals. However, it will be appreciated that a radio frequency link may be employed at maximum throughput up to a range of 20-30 metres (indoors), with 2-10 metres in a typical scenario.

It will be appreciated that the file transfer device may be provided with optical connections instead of USB cables. In this case, the file transfer device may be configured to work in one direction only, e.g. by adding a unidirectional data gateway element and/or a unidirectional data diode.

In the above description, the file transfer device 5 is described for ease of understanding as having a number of discrete functional components or modules. Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities.

In the above embodiments, a number of software modules were described. As those skilled in the art will appreciate, the software modules may be provided in compiled or un-compiled form and may be supplied to the file transfer device as a signal over a computer network, or on a recording medium. Further, the functionality performed by part or all of this software may be performed using one or more dedicated hardware circuits. However, the use of software modules is preferred as it facilitates the updating of the file transfer device in order to update its functionalities.

Various other modifications will be apparent to those skilled in the art and will not be described in further detail here.

1. Apparatus for facilitating secure data transfer between two data processing devices, the apparatus comprising:
means for connecting to a first data processing device via a first interface;
means for receiving data from said first data processing device via said first interface;
means for storing said data received from said first data processing device in a data store;
means for connecting to a second data processing device via a second interface; and
means for providing said stored data to said second data processing device via said second interface;
wherein said apparatus is operable to render said stored data unreadable to either data processing device upon disconnection from at least one of said first data processing device and said second data processing device.

2. The apparatus according to claim 1, wherein said apparatus comprises means for encrypting said data received from said first device and wherein said means for storing said data is operable to store said data in an encrypted form.

3. The apparatus according to claim 2, wherein said apparatus is operable to render said data unreadable by deleting a key associated with said encrypted data.

4. The apparatus of claim 3 wherein said apparatus is operable to store said key in random access memory, RAM, key store whereby said key is deleted from said RAM key store when power to said RAM key store is removed.

5. The apparatus according to claim 1, wherein said apparatus is operable to render said data unreadable by at least one of reformatting, overwriting and deleting said stored data.

6. The apparatus of claim 5 wherein said means for storing said data received from said first data processing device is operable to store said data in a random access memory, RAM, data store whereby said apparatus is operable to render said data unreadable by virtue of said data being deleted from said RAM data store when power to said RAM data store is removed.

7. The apparatus according to claim 1, further comprising means for automatically formatting said data store on at least one of: connection via at least one of said first and second interface; and disconnection of at least one of said first and second interface; whereby to render any data stored therein on said connection or disconnection unreadable.

8. The apparatus according to claim 1, wherein at least one of said first and second interfaces comprises a Universal Serial Bus, USB, interface.

9. The apparatus according to claim 8, wherein said apparatus is integrated with a USB cable.

10. The apparatus according to claim 1, wherein said means for connecting to a first data processing device via a first interface and said means for connecting to a second data processing device via a second interface are provided in a common processing entity.

11. The apparatus according to claim 1, wherein said means for connecting to a first data processing device via a first interface is provided in a first processing entity, wherein said means for connecting to a second data processing device via a second interface is provided in a second processing entity and wherein said first and second processing entities are operable for communication with one another to facilitate provision of said stored data to said second data processing device.

12. The apparatus according to claim 11, wherein said first and second processing entities are operable for communication with one another via a wireless link.

13. The apparatus according to claim 11, wherein said first and second processing entities are operable for communication with one another via a wired link.

14. The apparatus according to claim 11, wherein said first and second processing entities are operable for communication with one another via an optical link.

15. The apparatus according to claim 11 wherein said first and second processing entities each have a respective data store for storing said data.

16. The apparatus according to claim 15 wherein said first and second processing entities are each operable to store said data in their respective data store in an encrypted form and wherein said first and second processing entities are operable for communication with one another to exchange a key associated with encryption of said encrypted data.

17. The apparatus according to claim 11, wherein said first and second processing entities are operable for communication with one another to render said stored data unreadable via said first or said second interface.

18. The apparatus according to claim 11, wherein said first and second processing entities are operable to be uniquely paired with one another whereby to inhibit communication with another similar processing entity.

19. The apparatus according to claim 1, wherein said apparatus is operable, in at least one configuration, to allow transfer of said data in one direction and to inhibit transfer of said data in the other direction.

20. The apparatus of claim 19 wherein said apparatus is operable to allow transfer of said data in one direction and to inhibit transfer of said data in the other direction by virtue of one of said first and second interfaces being configured to be a read only interface.

21. The apparatus of claim 19 wherein said apparatus is operable to allow transfer of said data in one direction and to inhibit transfer of said data in the other direction for a predetermined time period.

22. The apparatus of claim 21 wherein said apparatus is operable to start said predetermined time period when a write operation is performed via one of said first and second interfaces, and to inhibit a write operation via the other of said first and second interfaces, until expiry of said predetermined time period.

23. The apparatus of claim 19 wherein said apparatus comprises an optical link via which said data is transferred and wherein said apparatus is operable to allow transfer of said data in one direction and to inhibit transfer of said data in the other direction by virtue of a unidirectional optical element.

24. The apparatus according to claim 1, wherein said apparatus is operable, in at least one configuration, for transfer of said data bidirectionally.

25. The apparatus according to claim 1, wherein said apparatus is operable for transfer of said data unidirectionally or bidirectionally depending on configuration.

26. A computer implementable instructions product comprising computer implementable instructions for causing a programmable device to become configured as the apparatus according to claim 1.

27. A system comprising: the apparatus according to claim 1; and at least one data processing device.

28. A method performed by an apparatus according to claim 1, the method comprising:
connecting said apparatus to said first data processing device via said first interface;
connecting said apparatus to said second data processing device via said second interface;
receiving data from said first data processing device via said first interface when a connection to said first data processing device via said first interface has been made;
storing said data received from said first data processing device in said data store;
providing said stored data to said second data processing device via said second interface; and
rendering said stored data unreadable to either data processing device upon disconnection from at least one of said first data processing device and said second data processing device.
